(19) United States
(12) Patent Application Publication
(10) Pub. No.: US 2025/0065441 A1
(43) Pub. Date: Feb. 27, 2025

(54) CONTROLLED LASER CUTTING HEAD

(71) Applicant: SAUDI ARABIAN OIL COMPANY, Dhahran (SA)

(72) Inventor: Sameeh Issa Batarseh, Dhahran (SA)

(73) Assignee: SAUDI ARABIAN OIL COMPANY, Dhahran (SA)

(21) Appl. No.: 18/454,736

(22) Filed: Aug. 23, 2023

(51) Int. Cl. B23K 26/14; B23K 26/38; B23K 26/70; E21B 29/00

(52) U.S. Cl. CPC B23K 26/1462; B23K 26/38; B23K 26/703; E21B 29/00

(57) ABSTRACT

A laser cutting tool includes a tool body having a central axis; a laser cutting head provided coaxially along the central axis of the tool body; and a laser head disposed on a side of the laser cutting head. The laser head includes a laser exit. An internal laser passageway extends in a radial direction between the laser cutting head and the laser exit configured to direct a laser beam from the laser cutting head in a radially outward direction through the laser exit. A plurality of internal nozzles positioned within the laser head configured to direct a cooling substance to a cutting area around the laser beam and a plurality of adjacent cutting zones around the cutting area. The plurality of internal nozzles are arranged parallel to the internal laser passageway.

### BACKGROUND

In the oil and gas industry, fracturing operations are performed to establish communication between a formation and a wellbore for production. Fracturing technology relies on pumping high volumes of highly pressurized fracturing fluid down the wellbore to the formation, where the pressure of the fracturing fluid exceeds the formation breaking pressure, creating fractures. Fractures are stress dependent, such that propagation of fractures in the formation is controlled by stress orientation. As a result, fractures may propagate in directions that bypass of some hydrocarbons in the formation thereby reducing the rate of hydrocarbon production and/or the total hydrocarbon ultimately produced. A method of fracturing that prevents or reduces the amount of bypassed hydrocarbon is therefore desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a laser cutting tool, comprising: a tool body having a central axis; a laser cutting head provided coaxially along the central axis of the tool body; a laser head disposed on a side of the laser cutting head, the laser head comprising a laser exit; an internal laser passageway extending in a radial direction between the laser cutting head and the laser exit configured to direct a laser beam from the laser cutting head in a radially outward direction through the laser exit; a plurality of internal nozzles positioned within the laser head configured to direct a cooling substance to a cutting area around the laser beam and a plurality of adjacent cutting zones around the cutting area; and wherein the plurality of internal nozzles are arranged parallel to the internal laser passageway.

In one aspect, embodiments disclosed herein relate to a method, comprising: lowering a laser cutting tool into a wellbore drilled into a subsurface formation, wherein the laser cutting tool comprises: a tool body; a laser cutting head positioned along the tool body; and a plurality of internal nozzles positioned within a laser head disposed on the laser cutting head; directing a laser beam from the laser cutting head in a radially outward direction to cut into a cutting area in the wellbore; and injecting, via the plurality of internal nozzles, the cutting area and a plurality of adjacent cutting zones around the cutting area with a cooling substance.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an exemplary hydraulic fracturing system.

FIG. 2 shows a conventional laser cutting tool with external nozzles in accordance with one or more embodiments.

FIG. 3 shows a laser cutting area in accordance with one or more embodiments.

FIG. 4 shows a laser cutting tool in accordance with one or more embodiments.

FIG. 5 shows a detailed view of components in a laser cutting tool in accordance with one or more embodiments.

FIG. 6 shows a laser cutting tool in accordance with one or more embodiments deployed in a well.

FIG. 7 shows a laser cutting tool head tip configuration in accordance with one or more embodiments.

FIG. 8 shows a laser cutting tool without purging in accordance with one or more embodiments.

FIG. 9 shows a laser cutting tool with purging in accordance with one or more embodiments.

FIG. 10 shows a cross sectional view of the laser cutting tool with purging in accordance with one or more embodiments.

FIG. 11 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fracture” includes reference to one or more of such fractures.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

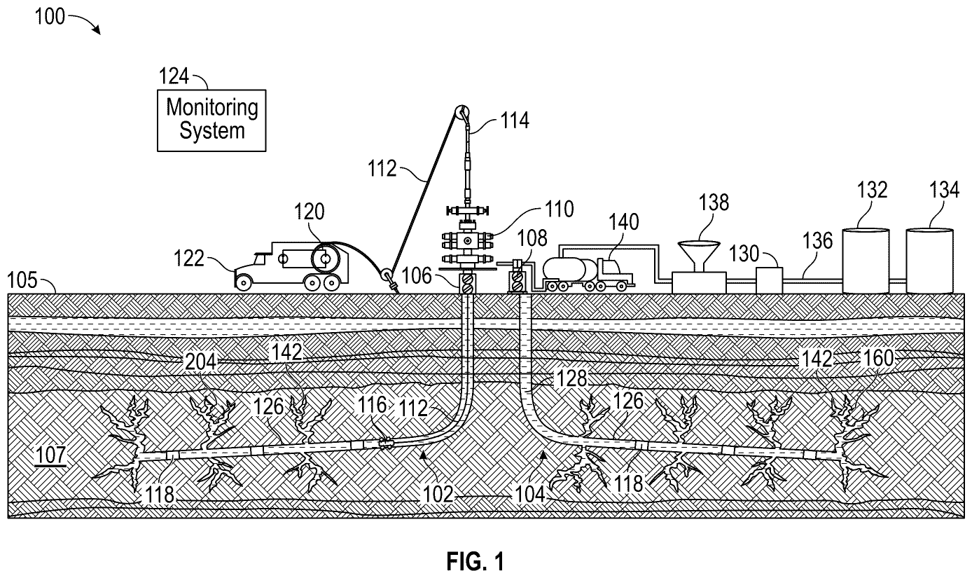

In the following description of FIGS. 1-11, any component described with regard to a figure, in various embodiments disclosed herein, may be equivalent to one or more like-named components described with regard to any other figure. For brevity. descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to a laser cutting tool and a method for using the laser cutting tool. More specifically, embodiments disclosed herein relate to using a laser cutting head, which may emit a controlled laser beam, to create a laser cut within a formation. The laser beam is controlled using internal nozzles in the laser cutting tool that direct a cooling substance around the laser beam to cool an area around the laser cut.

FIG. 1 shows an example of an exemplary hydraulic fracturing site (100) undergoing a hydraulic fracturing operation in accordance with one or more embodiments. The particular hydraulic fracturing operation and hydraulic fracturing site (100) shown is for illustration purposes only. The scope of this disclosure is intended to encompass any type of hydraulic fracturing site (100) and hydraulic fracturing operation. In general, a hydraulic fracturing operation includes two separate operations: a perforation operation and a pumping operation.

A hydraulic fracturing operation is performed in stages and on multiple wells that are geographically grouped. A singular well may have anywhere from one to in excess of forty stages. Typically, each stage includes one perforation operation, that may generate a plurality of adjacent perforations, and one pumping operation. While a perforation operation is occurring on one well, a pumping operation may be performed on the other well. As such, FIG. 1 shows an example hydraulic fracturing operation occurring on a first well (102) and a second well (104), each extending from the surface (105) to a formation (107). The first well (102) is depicted as undergoing the perforation operation and the second well (104) is shown as undergoing the pumping operation.

The first well (102) and the second well (104) are horizontal wells meaning that each well includes a vertical section and a diverging section. The diverging section is a section of the well that is drilled at least eighty degrees from vertical. However, fracturing operations may be performed on vertical wells and less deviated wells and the well trajectory illustrated in FIG. 1 is not intended to limit the claimed invention in any way. The first well (102) is capped by a first frac tree (106) and the second well (104) is capped by a second frac tree (108). A frac tree (106, 108) is similar to a production tree but is specifically installed for hydraulic fracturing operation. Frac trees (106, 108) tend to have larger bores and higher-pressure ratings than a production tree would have. Further, hydraulic fracturing operations require abrasive materials being pumped into the well at high pressures, so the frac tree (106, 108) is designed to handle a higher rate of erosion.

The first well (102) and the second well (104) are shown as requiring four stages, as an example. Both the first well (102) and the second well (104) have undergone three stages and are undergoing the fourth stage. The second well (104) has already undergone the fourth stage perforation operation and is currently undergoing the fourth stage pumping operation. The first well (102) is undergoing the fourth stage perforating operation and has yet to undergo the fourth stage pumping operation.

The perforating operation includes installing a wireline blow out preventor (BOP) (110) onto the first frac tree (106). A wireline BOP (110) is similar to a drilling BOP; however, a wireline BOP (110) has seals designed to close around (or shear) wireline (112) rather than drill pipe. A lubricator (114) is connected to the opposite end of the wireline BOP (110). A lubricator (114) is a long, high-pressure pipe used to equalize between downhole pressure and atmosphere pressure in order to run downhole tools, such as a perforating gun (116), into the well.

The perforating gun (116) is lowered into the first well (102) using the lubricator (114), wireline (112), and fluid pressure. In accordance with one or more embodiments, the perforating gun (116) is equipped with explosives and a frac plug (118) prior to being deployed in the first well (102). The wireline (112) is connected to a spool (120) often located on a wireline truck (122). Electronics (not pictured) included in the wireline truck (122) are used to control the unspooling/spooling of the wireline (112) and are used to send and receive messages along the wireline (112). The electronics may also be connected, wired or wirelessly, to a monitoring system (124) that is used to monitor and control the various operations being performed on the hydraulic fracturing site (100).

When the perforating gun (116) reaches a predetermined depth, a message is sent along the wireline (112) to set the frac plug (118) to seal the section of the well in the stage being performed. After the frac plug (118) is set, another message is sent through the wireline (112) to detonate the explosives, as shown in FIG. 1. The explosives create perforations in the casing (126) and in the surrounding formation. There may be more than one set of explosives on a singular perforation gun (116), each detonated by a distinct message. Multiple sets of explosives are used to perforate different depths along the casing (126) for a singular stage. Further, the frac plug (118) may be set separately from the perforation operation without departing from the scope of the disclosure herein.

As explained above, FIG. 1 shows the second well (104) undergoing the pumping operation after the fourth stage perforating operation has already been performed and perforations are left behind in the casing (126) and the surrounding formation. A pumping operation includes pumping a frac fluid (128) into the perforations in order to propagate the perforations and create fractures (142) in the surrounding formation. The frac fluid (128) often comprises a certain percentage of water, proppant, and chemicals.

FIG. 1 shows chemical storage containers (130), water storage containers (132), and proppant storage containers (134) located on the hydraulic fracturing site (100). Frac lines (136) and transport belts (not pictured) transport the chemicals, proppant, and water from the storage containers (130, 132, 134) into a frac blender (138). A plurality of sensors (not pictured) is located throughout this equipment to send signals to the monitoring system (124). The monitoring system (124) may be used to control the volume of water, chemicals, and proppant used in the pumping operation.

The frac blender (138) blends the water, chemicals, and proppant to become the frac fluid (128). The frac fluid (128) is transported to one or more frac pumps, often pump trucks (140), to be pumped through the second frac tree (108) into the second well (104). Each pump truck (140) includes a pump designed to pump the frac fluid (128) at a certain pressure. More than one pump truck (140) may be used at a time to increase the pressure of the frac fluid (128) being pumped into the second well (104). The frac fluid (128) is transported from the pump truck (140) to the second frac tree (108) using a plurality of frac lines (136).

The fluid pressure propagates and creates the fractures (142) while the proppant props open the fractures (142) once the pressure is released. Different chemicals may be used to lower friction pressure, prevent corrosion, etc. The pumping operation may be designed to last a certain length of time to ensure the fractures (142) have propagated enough. Further the frac fluid (128) may have different make ups throughout the pumping operation to optimize the pumping operation without departing from the scope of the disclosure herein.

Through the fracturing process shown in FIG. 1, a number of fractures (142) may extend from the wellbore into the formation (107). The propagation of the fractures (142) is dependent on stress orientation. Accordingly, the fractures (142) may propagate in multiple directions, such that one or more bypassed zones (160) are created in a somewhat randomized pattern. A bypassed zone (160) may refer to a region in which hydrocarbons within the formation (107) are bypassed by fractures (142), such that the full production potential of the formation (107) is not achieved.

According to embodiments of the present disclosure, fracture bypassed zones may be prevented by using a laser cutting tool disclosed herein to form relatively uniform cuts through a surrounding formation. As described in more detail below, a laser cutting tool according to embodiments of the present disclosure may include one or more laser cutting heads designed to direct a laser beam by injecting a cooling substance from internal nozzles in the laser cutting tool outwardly from the laser cutting head. In such manner, the laser beam may travel linearly into a surrounding formation, thereby forming a cut into the surrounding formation along a single plane transverse to the wellbore. Thus, unlike fractures (142) formed by conventional fracturing processes (e.g., by perforation guns (116)), which extend in multiple directions according to surrounding formation characteristics (e.g., stress concentrations, heterogeneities, and physical discontinuities in the rock), cuts formed by a laser cutting tool may be controlled directed to a cutting zone.

According to embodiments of the present disclosure, a laser cutting tool may be lowered into a well to form cuts through a surrounding formation in the alternative to forming conventional fractures. In some embodiments, a laser cutting tool may be used to form cuts through a surrounding formation after forming conventional fractures (142), such as in the first well (102) shown in FIG. 1 to cut through one or more bypassed zones (160).

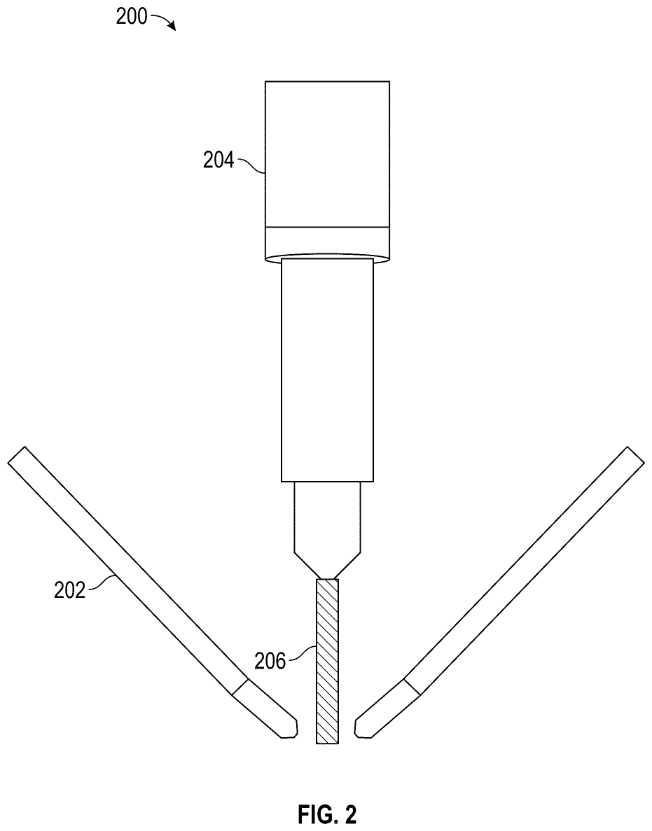

FIG. 2 shows a conventional laser cutting tool (200) with external nozzles (202). The conventional laser cutting tool (200) may include a conventional laser head (204) designed to emit a laser beam (206) used to cut material, such as formations (107). The heat generated from the laser beam (206) causes thermomechanical stresses on the material targeting by the laser beam (206). The speed of cutting the material and the number of times the laser beam (206) is emitted may be adjusted to reduce laser time spent on target. The external nozzles (202) may be capable of coaxially purging. Coaxial purging occurs when the external nozzles (202) use a fluid or gas to cool down a cutting area and remove debris under the laser beam (206) to facilitate further laser cutting.

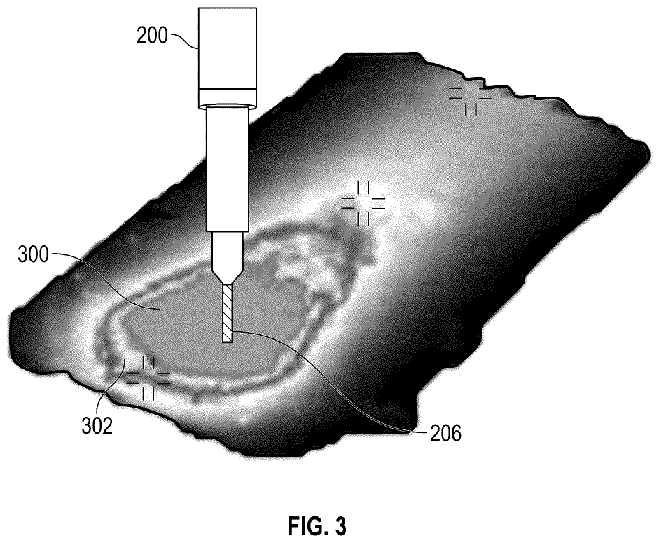

FIG. 3 shows a laser cutting area (300) of the conventional laser cutting tool (200). Specifically, FIG. 3 shows the heat effect of cutting on material using the conventional laser cutting tool (200) described in FIG. 2. The external nozzles (202) purge at an angle to target the laser cutting area (300). Thus, the heat from the laser beam (206) propagates to an adjacent zone (302) causing a thermomechanical effect. The thermal effect may cause alterations and weakening of material targeted by the laser beam (206), such as the adjacent zone (302). The adjacent zone (302) surrounds the laser cutting area (300). The adjacent zone (302) may vary in size depending on several factors including a material's physical and thermal properties, laser intensity, and laser time spent on the laser cutting area (300) target. The amount of time the laser beam (206) spends on the laser cutting area (300) may cause the adjacent zone to become brittle and easily break.

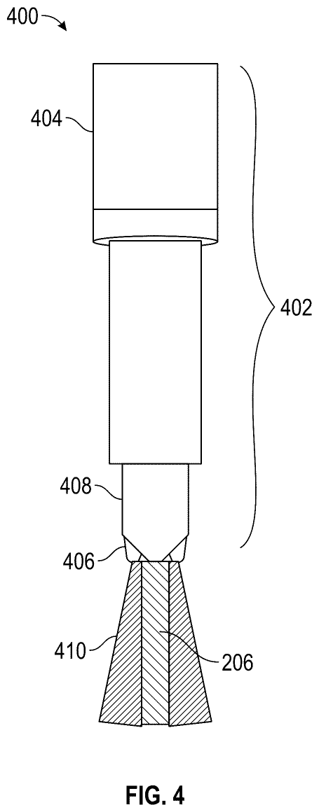

FIG. 4 shows a laser cutting tool (400) in accordance with one or more embodiments. The laser cutting tool (400) includes a tool body (402) having a laser cutting head (404) designed to direct a laser beam (206) radially outwardly from the laser cutting tool (400). The laser cutting tool (400) includes a plurality of internal nozzles (406). The internal nozzles (406) are positioned within a laser head (408) disposed on a side of the laser cutting head (404). The internal nozzles (406) may be fluid nozzles capable of injecting a substance or fluid parallel to the laser beam (206) emitted from the laser cutting head (404). The internal nozzles (406) may inject a cooling substance into a purging zone (410). The purging zone (410) may be the area parallel and around the laser beam (206). The purging zone (410) prevents unwanted spreading of the heat effect from the laser beam (206). The number of internal nozzles (406) may be selected to produce a desired flow rate. The internal nozzles (406) may inject a substance, such as a gas or liquid. The gas used, for example, may be an inert gas, such as nitrogen.

In one or more embodiments, the laser cutting tool (400) is deployed in a well, such as the first well (102) or second well (104) described in FIG. 1. The substance source supplying the gas or liquid may be located at the surface (105).

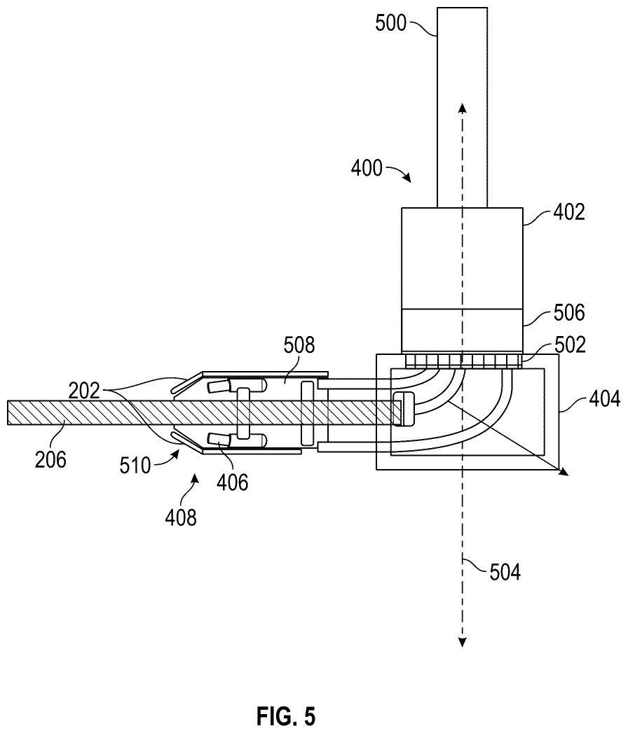

FIG. 5 shows the laser cutting tool (400) in accordance with one or more embodiments. In the embodiment shown, the laser cutting head (404) is shown in an enlarged and cross-sectional view in order to show internal components and details of the tool body (402). However, in one or more embodiments, a laser cutting head (404) may have an outer diameter approximately the same size as the tool body (e.g., where the laser cutting head outer diameter is within 5 percent of the tool body outer diameter). In one or more embodiments, additional laser cutting heads may be axially spaced apart along the tool body (402) and coaxially aligned.

The tool body (402) may be connected at an axial end to a wireline or coiled tubing (500) to be lowered into a well. In one or more embodiments, the tool body (402) may be configured to withstand high temperatures and high pressures, such as those typically associated with the fracturing process at a formation (107). In one or more embodiments, the laser beam (206) may be generated at the surface (105) and delivered to a laser cutting head (404). In other embodiments, the laser beam (206) may be generated in-situ at a downhole location. The laser cutting head (404) is provided coaxially along a central axis of the tool body (402). In some embodiments, a mechanical gear (502) may be secured between the laser cutting head (404) and the tool body (402) to rotate the laser cutting head (404) relative to the tool body (402) about the central axis (504). In one or more embodiments, the mechanical gear may be rotated by a motor (506) that is hydraulically or electrically powered. In some embodiments, such motor (506) may be provided in the tool body (402) and connected to a gear assembly (including one or more gears (502)) in the laser cutting head to rotate the laser cutting head (404). The laser cutting head (404) may be coaxially aligned with the tool body (402), such that the laser cutting head (404) may rotate about the central axis (504) of the tool body (402).

Looking further in FIG. 5, the laser beam (206) may be directed through an internal passageway (508) and out of an exit (510) (an opening) provided through a laser head (408) on the laser cutting head (404). The internal laser passageway (508) may extend through the laser cutting head (404) in a radial direction between the central axis (504) of the laser cutting tool (400) and the exit (510) in the laser head. The laser head (408) (and exit (510)) is provided around a side of the laser cutting head (404).

The internal nozzles (406) may be integrally formed within the laser cutting head (404). The internal nozzles (406) may include fluid openings oriented to direct fluid parallel to the laser beam (206) emitted from the laser cutting head (404). A flow path from a fluid source to the internal nozzles (406) may be provided through coiled tubing (500), the tool body (402), and the laser cutting head (404) via fluidly connected passages through the assembly. The laser cutting tool (400) may include one or more external nozzles (202) for clearing any debris from the path of the laser beam (206) as described in FIG. 2. In one or more embodiments, the laser cutting tool (400) may include one or more annular flow paths, which may fluidly connect flow passages between the tool body (402) and the laser cutting head (404) as the laser cutting head (404) rotates relative to the tool body (402). In some embodiments, the entire laser cutting tool (400) may rotate (rotating the laser cutting head (404) together with the tool body (402)). In such embodiments, one or more annular flow paths may fluidly connect flow passages between the laser cutting tool (400) and the coiled tubing (500).

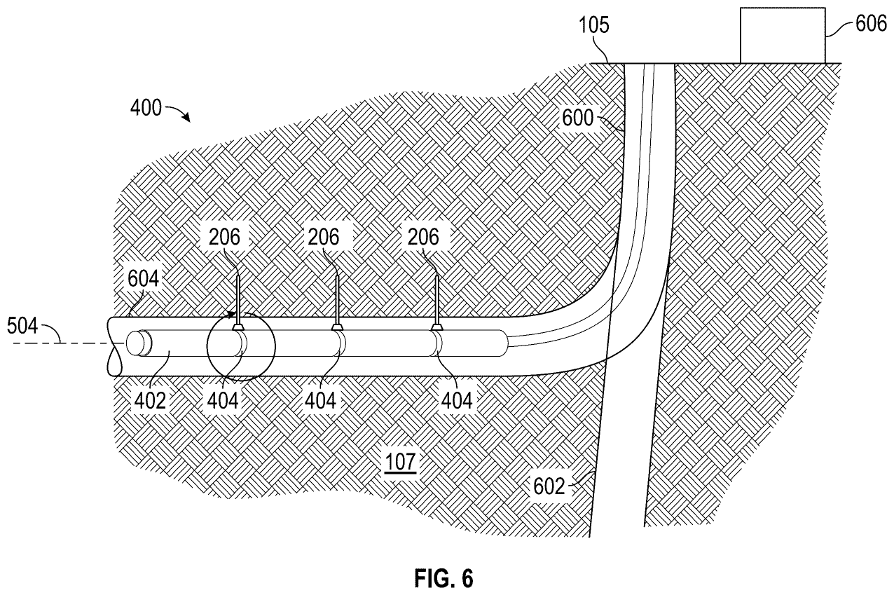

FIG. 6 shows the laser cutting tool (400) in accordance with one or more embodiments deployed in a well (600). The well (600) may extend from the surface (105) to a formation (107). In one or more embodiments, the well (600) may be vertical, horizontal, or a directional well. In horizontal wells, as shown in FIG. 6, there may be a primary wellbore (602) which may extend into the ground in a substantially vertical direction and a lateral section (604) which may diverge from the primary wellbore (602) at a kick-off point at an angle until the lateral section (604) is substantially horizontal. In the embodiment shown, the laser cutting tool (400) is positioned in the lateral section (604) of the well (600). However, laser cutting tools according to embodiments of the present disclosure may be operated in other directional or vertical wells sections of a well.

The laser cutting tool (400) may be powered from the surface (105) by a laser power generator (606). The laser power generator (606) may be a diesel generator configured to provide electrical power to generate laser energy. The laser cutting tool (400) may be pushed (e.g., on coiled tubing or lowered on a wireline) or pulled (e.g., on a borehole tractor) from one depth to another. When positioned in a selected location of a well (600), a laser beam (206) may be generated by the laser power generator (606) and directed to one or more laser cutting heads (404). The laser beam (206) may be directed outwardly from an exit (510) on the laser cutting head (404) and into the formation (107) around the well (600). The laser beam (206) may be continuously emitted by the laser cutting head (404). In one or more embodiments, the laser cutting tool (400) may include more than one laser cutting head (404).

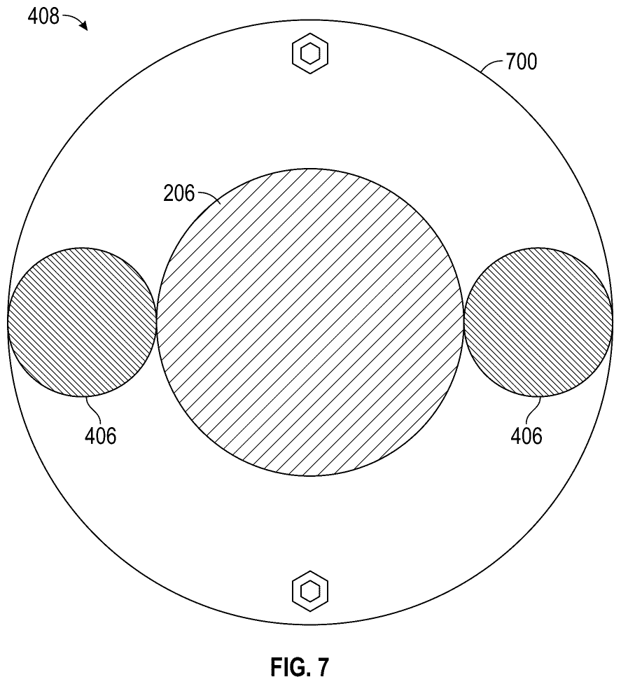

FIG. 7 shows a laser cutting tool head tip (700) configuration in accordance with one or more embodiments. Specifically, FIG. 7 shows the laser cutting head tip (700) inside of the laser head (408) with two internal nozzles (406) and the laser beam (206). The internal nozzles (406) may be positioned as shown in FIG. 7 to inject or purge a cooling substance parallel to the laser beam (206) upon exiting the laser head (408). The cooling substance may be any gas or liquid that is capable of preventing or minimizing heat transfer. The internal nozzles (406) may be configured to spread out the cooling substance to converge more area of the cutting area (300) and adjacent zones (302).

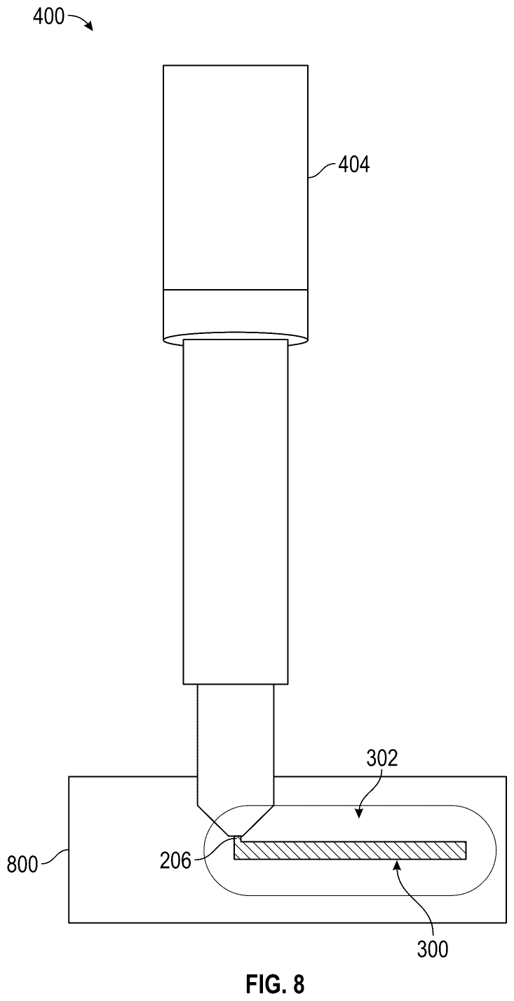

FIG. 8 shows a laser cutting tool (400) without purging in accordance with one or more embodiments. Purging is the act of activating the internal nozzles (406) during laser cutting. Specifically, FIG. 8 shows the laser cutting head (404) emitting a laser beam (206) on a work piece (800). The work piece (800) may be any cutting surface such as a metal material or wellbore. The adjacent zone (302) is shown in adjacent areas around the cutting area (300) of the laser beam (206). The adjacent zone (302) is thermally affected by the laser beam (206). The work piece (800) may become brittle or break around the adjacent zone (302) due to the heat transfer of the laser beam (206).

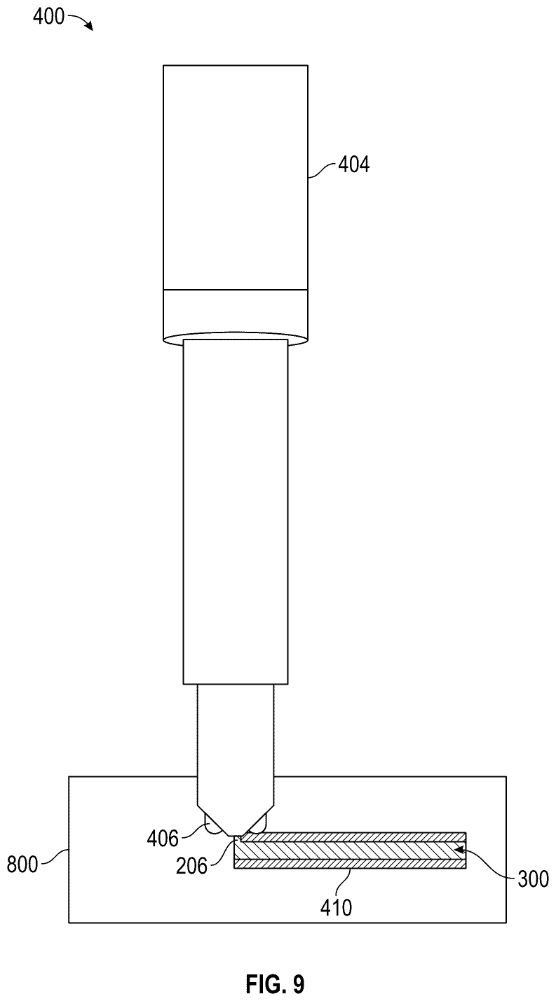

FIG. 9 shows a laser cutting tool (400) with purging in accordance with one or more embodiments. Specifically, FIG. 9 shows the laser cutting head (404) emitting the laser beam (206) on the work piece (800) while purging using the internal nozzles (406). The internal nozzles (406) create a purging zone (410) by injecting a cooling substance in adjacent areas around the cutting area (300) or the laser beam (206). The purging zone (410) prevents or reduces thermal transfer to reduce the adjacent zone (302) shown in FIG. 8 by cooling the adjacent zone (302). The internal nozzles (406) may also cause coaxial purging to clear out any debris to clear a path for the laser beam (206). Coaxial purging occurs when the laser beam (206) and cooling substance flow and exit in the same direction. The cooling substance may be selected based on the material of the work piece (800) and characteristics of the laser beam (206) such as intensity. A larger thermal differential between the material of the work piece (800) and the laser beam (206) may cause the adjacent zone (302) to become brittle. The control substance may be used to control heat transfer and prevent brittleness in the material of the work piece (800).

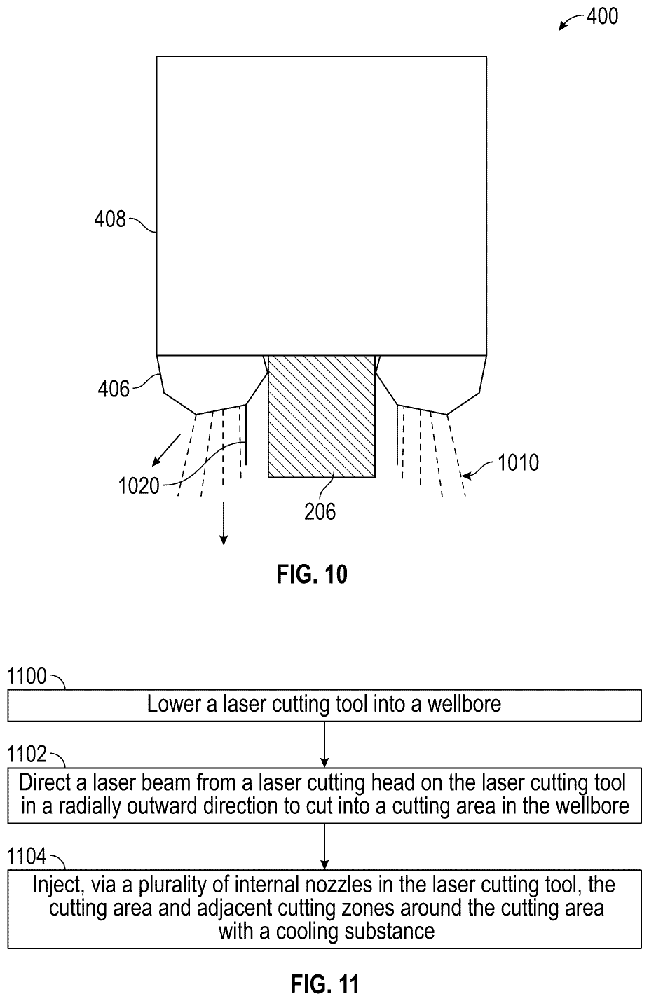

FIG. 10 shows a cross sectional view of the laser cutting tool (400) with purging in accordance with one or more embodiments. Specifically, FIG. 10 shows the laser beam (206) emitted from the laser head (408). The internal nozzles (406) injecting a substance adjacent to the laser beam (206) creating a purging flow (1010). The purging flow (1010) illustrates a flow guide (1020) and direction of a straight line. The purging flow (1010) direction is shown by two arrows in FIG. 10 to illustrate the straight-line direction along the side of the laser beam (206) and radially outward direction away from the laser beam (206). Rather than the purging flow (1010) occurring under the laser beam (206), the purging flow (1010) is directed at the edge of the laser beam (206). As illustrated in FIG. 10, the internal nozzles (406) may be placed at an angle to direct purging flow (1010) towards the laser beam (206) where the flow guide (1020) directs the purging flow (1010) as desired.

FIG. 11 depicts a flowchart in accordance with one or more embodiments. More specifically, FIG. 11 depicts a flowchart of a method of creating a transverse fracture in a formation. Further, one or more blocks in FIG. 11 may be performed by one or more components described in FIGS. 1-10. While the various blocks in FIG. 11 are presented and described sequentially, one or ordinary skill in the art will appreciate that some or all of the blocks may be executed in different orders, may be combined, may be omitted, and some or all of the blocks may be executed in parallel. Furthermore, the blocks may be performed actively or passively.

Initially in Block 1100, a laser cutting tool (400) may be suspended in a borehole or a wellbore. In particular, the laser cutting tool (400) may be lowered from a wellhead at the surface (105) into a well (such as the first well (102) or the second well (104)) to a subsurface formation (107). Specifically, the laser cutting tool (400) may be lowered down the wellbore to a desired fracturing location within the formation (107). In one or more embodiments, the laser cutting tool (400) may include a tool body (402) a laser cutting head (404) positioned along the tool body (402), and a plurality of internal nozzles (406) positioned within a laser head on the laser cutting head (404). The internal nozzles (406) may be axially spaced apart from one another.

In Block 1102, a laser beam (206) may be directed from the laser cutting head (404) in a radially outward direction to cut into a cutting area (300) in the wellbore. The laser beam (206) may be generated and powered by a laser power generator (606) located at the surface (105) of the earth and transmitted downhole through coiled tubing. The laser beam (206) generates heat on variable intensity and power. In one or more embodiments, the laser beam (206) creates a laser cut in the wellbore creating a transverse fracture. In Block 1104, the internal nozzles (406) inject the cutting area (300) and adjacent zones (302) around the cutting area (300) with a cooling substance. The cooling substance may be a gas or fluid such as water or inert gas. The cooling substance may be used to control heat transfer from the laser beam (206) to prevent brittleness in the wellbore, thereby preventing debris. As the cooling substance is injected parallel to the laser beam (206), the laser beam (206) may provide clean and effective cuts and avoid pipe damage and failure.

The method described above may be repeated until the transverse fracture reaches a desired depth. Transverse fractures may allow for radial flow of hydrocarbons from the formation (107) into the wellbore. Further, transverse fractures may maximize flow due to a larger reservoir contract than in traditional hydraulic fractures.

Embodiments of the present disclosure may provide at least one of the following advantages. Traditional hydraulic fracturing operations are characterized by propagating fractures, the formation of which is largely dependent on stress orientation. As such, there are many bypassed zones which exist, meaning that a significant volume of hydrocarbon potential within formation is not produced. Embodiments of the present disclosure employ a laser cutting tool for the creation of transverse fractures. Transverse fractures can be created and sized to a desired depth, covering all areas within a formation, effectively eradicating any bypassed zones which may have existed with the use of traditional methods. Further, creation of transverse fractures may increase flow from the formation to the wellbore due to maximized reservoir contact. Use of a high powered laser, such as the controlled laser cutting tool described herein, is a non-damaging technology which provides suitable stimulation for formation rock samples.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A laser cutting tool, comprising:
a tool body having a central axis;
a laser cutting head provided coaxially along the central axis of the tool body;
a laser head disposed on a side of the laser cutting head, the laser head comprising a laser exit;
an internal laser passageway extending in a radial direction between the laser cutting head and the laser exit configured to direct a laser beam from the laser cutting head in a radially outward direction through the laser exit;
a plurality of internal nozzles positioned within the laser head configured to direct a cooling substance to a cutting area around the laser beam and a plurality of adjacent cutting zones around the cutting area; and
wherein the plurality of internal nozzles are arranged parallel to the internal laser passageway.

2. The laser cutting tool of claim 1, wherein the laser beam is configured to cut into a wellbore.

3. The laser cutting tool of claim 1, wherein the laser beam is configured to cut into metal materials.

4. The laser cutting tool of claim 1, wherein the plurality of internal nozzles are axially spaced apart from one another.

5. The laser cutting tool of claim 1, wherein the cooling substance is a gas.

6. The laser cutting tool of claim 1, wherein the cooling substance is a fluid.

7. The laser cutting tool of claim 1, wherein the laser beam is generated from a laser generator at a surface around a wellbore.

8. The laser cutting tool of claim 1, wherein the laser beam generates heat.

9. A method, comprising:
lowering a laser cutting tool into a wellbore drilled into a subsurface formation, wherein the laser cutting tool comprises:
a tool body;
a laser cutting head positioned along the tool body; and
a plurality of internal nozzles positioned within a laser head disposed on the laser cutting head;
directing a laser beam from the laser cutting head in a radially outward direction to cut into a cutting area in the wellbore; and
injecting, via the plurality of internal nozzles, the cutting area and a plurality of adjacent cutting zones around the cutting area with a cooling substance.

10. The method of claim 9, wherein the plurality of internal nozzles are axially spaced apart from one another.

11. The method of claim 9, wherein the cooling substance is a gas.

12. The method of claim 9, wherein the cooling substance is a fluid.

13. The method of claim 9, further comprising generating the laser beam from a laser generator at a surface around the wellbore.

14. The method of claim 9, wherein the laser cutting tool is lowered into the wellbore by an end of a coiled tubing.

15. The method of claim 9, further comprising generating heat, via the laser beam.
